(19) United States
(12) Patent Application Publication
(10) Pub. No.: US 2020/0019010 A1
(43) Pub. Date: Jan. 16, 2020

(54) SWITCHING DEVICE AND DISPLAY DEVICE

(71) Applicant: SHARP KABUSHIKI KAISHA, Sakai City (JP)

(72) Inventors: NARU USUKURA, Sakai City (JP); KIYOSHI MINOURA, Sakai City (JP)

(21) Appl. No.: 16/509,897

(22) Filed: Jul. 12, 2019

Related U.S. Application Data
(60) Provisional application No. 62/698,396, filed on Jul. 16, 2018.

(51) Int. Cl. G02F 1/1335; G02F 1/1334; G02F 1/1347; G02F 1/137

(52) U.S. Cl. CPC G02F 1/133504; G02F 1/1334; G02F 1/133536; G02F 1/13476; G02F 2203/02; G02F 1/13362; G02F 2203/03; G02F 2001/133557; G02F 1/13718

(57) ABSTRACT

The switching device of the present invention includes a switching liquid crystal cell switchable between a switching mode of converting a vibration direction of incident polarized light and a non-switching mode of not converting the vibration direction of the incident polarized light; an anisotropic light scattering layer configured to scatter incident light at a specific azimuth; and a polarized light reflective layer, wherein in the anisotropic light scattering layer, a haze is 50% or higher and a full width at half maximum of luminance at a first azimuth is greater than a full width at half maximum of the luminance at a second azimuth and less than ten times the full width at half maximum of the luminance at the second azimuth, the first azimuth being the specific azimuth where the scattered light has maximum intensity, the second azimuth being an azimuth where the scattered light has minimum intensity.

### CROSS-REFERENCE TO RELATED APPLICATIONS

The present application claims priority under 35 U.S.C. 119 to U.S. Provisional Patent Application No. 62/698,396 filed on Jul. 16, 2018, the contents of which arc incorporated herein by reference in their entirety.

### BACKGROUND OF THE INVENTION

### Field of the Invention

The present invention relates to switching devices and display devices.

### Description of Related Art

Display devices such as liquid crystal display devices have a screen that just turns black in a non-display state, and thus their designs are desired to be better. Some techniques developed in response to the desire are those disclosed in, for example, WO 2015/141350, JP 2003-202565 A, and JP 2039-510513 T, which dispose a half mirror layer on the front surface side of the display device to provide a function as a mirror to the display device.

### BRIEF SUMMARY OF THE INVENTION

In terms of the design compatibility, the appearance of the display device in the non-display state is desired to be white as seen in the housings of many home appliances. For example, WO 2015/141350 discloses a mirror display sequentially including a liquid crystal display device, a reflective polarizer used as a half mirror layer, and a light-diffusing member. Such a mirror display is described as able to match the surroundings having diffusely reflecting surfaces in the mirror mode. However, the studies made by the present inventors found that the mirror display can still be improved in achieving a white appearance with a high reflectance (i.e., sufficient brightness). The studies also found that the arts described in JP 2003-202565 A and JP 2009-510513 T can still be improved as with the mirror display in WO 2015/141350.

In response to the above issues, an object of the present invention is to provide a switching device capable of achieving a white appearance with a high reflectance and a display device including the switching device.

The present inventors made various studies on switching devices capable of achieving a white appearance with a high reflectance. The studies found that combining a switching liquid crystal display panel, a polarized light reflective layer, and an anisotropic light scattering layer enables achievement of a white appearance with a high reflectance. The inventors thereby successfully achieved the above object, completing the present invention.

(1) One embodiment of the present invention is directed to a switching device including: a switching liquid crystal cell switchable between a switching mode of converting a vibration direction of incident polarized light and a non-switching mode of not converting the vibration direction of the incident polarized light; an anisotropic light scattering layer configured to scatter incident light at a specific azimuth; and a polarized light-reflective layer disposed on one or both of a side remote from the anisotropic light scattering layer of the switching liquid crystal cell and a side close to the anisotropic light scattering layer of the switching liquid crystal cell, wherein in the anisotropic light scattering layer, a haze is 50% or higher and a full width at half maximum of luminance at a first azimuth is greater than a full width at half maximum of the luminance at a second azimuth and less than ten times the full width at half maximum of the luminance at the second azimuth, the first azimuth being the specific azimuth where the light scattered by the anisotropic light scattering layer has maximum intensity, the second azimuth being an azimuth where the scattered light has minimum intensity.

(2) In an embodiment of the present invention, the switching device includes the structure and the polarized light reflective layer includes a first polarized light reflective layer disposed on the side remote from the anisotropic light scattering layer of the switching liquid crystal cell and a second polarized light reflective layer disposed on the side close to the anisotropic light scattering layer of the switching liquid crystal cell.

(3) In an embodiment of the present invention, the switching device includes the structure (2), and the first polarized light reflective layer and the second polarized light reflective layer each include at least one linearly polarized light reflector.

(4) In an embodiment of the present invention, the switching device includes the structure (3), and one or both of the first polarized light reflective layer and the second polarized light reflective layer include(s) a stack of two linearly polarized light reflectors whose reflection axes form an angle of 0° to 40°.

(5) In an embodiment of the present invention, the switching device includes the structure (2), and the first polarized light reflective layer and the second polarized light reflective layer each include a circularly polarized light reflector.

(6) In an embodiment of the present invention, the switching device includes the structure (5), and the circularly polarized light reflector includes a cholesteric liquid crystal.

(7) In an embodiment of the present invention, the switching device includes the structure (5) or (6), and a λ/4 retarder is disposed on a side remote from the switching liquid crystal cell of the first polarized light reflective layer.

(8) In an embodiment of the present Invention, the switching device includes any one of the structures (1) to (7), and the anisotropic light scattering layer includes a lenticular lens and an isotropic light scattering layer.

(9) In an embodiment of the present invention, the switching device includes any one of the structures (1) to (8), and the anisotropic light scattering layer includes an anisotropic microlens array.

(10) In an embodiment of the present invention, the switching device includes any one of the structures (1) to (9), and the anisotropic light scattering layer includes needle filler.

(11) Another embodiment of the present invention is directed to a display device including; a display module; and the switching device according to any one of the items (1) to (10).

(12) In an embodiment of the present invention, the display device includes the structure (11), and the display module is a liquid crystal display module including, in the following order toward the switching device, a backlight and a liquid crystal display panel.

(13) In an embodiment of the present invention, the display device includes the structure (11), and the display module is an organic electroluminescent display panel.

(14) In an embodiment of the present invention, the display device includes any one of the structures (11) to (13), the display module includes a display region where pixel regions providing display in different colors are arranged in stripes, and the specific azimuth where the light scattered by the anisotropic light scattering layer has maximum intensity is perpendicular to an azimuth where the stripes of the pixel regions extend.

(15) In an embodiment of the present invention, the display device includes any one of the structures (11) to (14), and the display module has light distribution characteristics that give a half-luminance angle of ±15° or smaller from a central axis defined as extending in a direction normal to a display surface.

The present invention can provide a switching device capable of achieving a white appearance with a high reflectance and a display device including the switching device.

### BRIEF DESCRIPTION OF THE DRAWINGS

FIG. 1 is a schematic cress-sectional view of a switching device and a display device of Embodiment 1.

FIG. 2 is a schematic cross-sectional view showing Structure Example 1 of an anisotropic light scattering layer.

FIG. 3 is a schematic cross-sectional view showing Structure Example 2 of the anisotropic light scattering layer.

FIG. 4 is a schematic perspective view showing Structure Example 3 of the anisotropic light scattering layer.

FIG. 5 is a schematic cross-sectional view illustrating the operating principle of the display device of Embodiment 1 in a non-display state.

FIG. 6 is a schematic cross-sectional view illustrating the operating principle of the display device of Embodiment 1 in a display state.

FIG. 7 is another schematic cross-sectional view illustrating the operating principle of the display device of Embodiment 1 in the display state.

FIG. 8 is a schematic plan view illustrating a preferred positional relationship between a liquid crystal display module and an anisotropic light scattering layer.

FIG. 9 is a schematic cross-sectional view of a switching device and a display device of Embodiment 2.

FIG. 10 is a schematic cross-sectional view illustrating the operating principle of the display device of Embodiment 2 in a non-display state.

FIG. 11 is a schematic cross-sectional view illustrating the operating principle of the display device of Embodiment 2 in a display state.

FIG. 12 is another schematic cross-sectional view illustrating the operating principle of the display device of Embodiment 2 in the display state.

### DETAILED DESCRIPTION OF THE INVENTION

The present invention is described in more detail based on the following embodiments with reference to the drawings. The embodiments, however, are not intended to limit the scope of the present invention. The configurations of the embodiments may appropriately be combined or modified within the spirit of the present invention.

Herein, “X to Y” means “X or more and Y or less”

### Embodiment 1

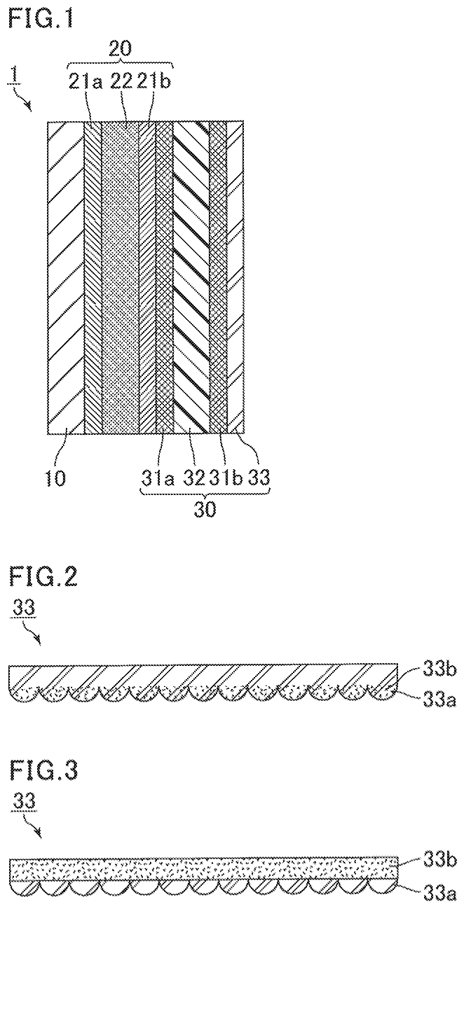

FIG. 1 is a schematic cross-sectional view of a switching device and a display device of Embodiment 1. As shown in FIG. 1, a display device 1 includes, in the following order, a liquid crystal display module including a backlight 10 and a liquid crystal display panel 20; and a switching device 30. The liquid crystal display module includes, in the following order toward the switching device 30, the backlight 10 and the liquid crystal display panel 20.

### <Backlight>

The backlight 10 can be a known one. The backlight 10 may be, for example, an edge-lit backlight or a direct-lit backlight. The light source of the backlight 10 is, for example, a light emitting diode (LED) or a cold cathode fluorescent lamp (CCFL).

### <Liquid Crystal Display Panel>

The liquid crystal display panel 20 includes, in the following order from the backlight 10 side to the switching device 30 side, an absorptive polarizer 21a, a liquid crystal cell 22, and an absorptive polarizer 21b.

The absorptive polarizers 21a and 21b are, for example, polarizers obtained by dyeing a polyvinyl alcohol film with an anisotropic material such as an iodine complex (or dye) to adsorb the anisotropic material on the film and stretching the film for alignment.

The liquid crystal cell 22 includes, for example, a liquid crystal layer between a pair of substrates. The pair of substrates may be, for example, a known combination of a thin-film transistor array substrate and a color filter substrate. The liquid crystal cell 22 may be, for example, a liquid crystal cell in the twisted nematic (TN) mode, the vertical alignment (VA) mode, the in-plane switching (IPS) mode, or the fringe field switching (FFS) mode.

The liquid crystal display module (liquid crystal display panel 20) is switchable between a display mode and a non-display mode by, for example, adjusting the positional relationship between the transmission axes (absorption axes) of the absorptive polarizers 21a and 21b in consideration of the alignment state of the liquid crystal molecules in the liquid crystal cell 22 (liquid crystal layer). In the display mode, the liquid crystal display panel 20 emits light from the backlight 10 as linearly polarized light (display light) to the switching device 30 side thereof. In the non-display mode, the liquid crystal display panel 20 does not emit the light as linearly polarized light (display light) to the switching device 30 side thereof. For example, the liquid crystal display panel 20, when it is in a normally black mode, emits linearly polarized light to the switching device 30 side thereof (i.e., display mode) with voltage applied to the liquid crystal cell 22 (liquid crystal layer), while emitting no linearly polarized light to the switching device 30 side thereof (i.e., non-display mode) with no voltage applied to the liquid crystal cell 22 (liquid crystal layer). Also, for example, the liquid crystal display panel 20, when It is in a normally white mode, emits no linearly polarized light to the switching device 30 side thereof (i.e., non-display mode) with voltage applied to the liquid crystal cell 22 (liquid crystal layer), while emitting linearly polarized light (display light) to the switching device 30 side thereof (i.e., display mode) with no voltage applied to the liquid crystal cell 22 (liquid crystal layer). In the non-display mode of the liquid crystal display panel 20, the backlight 10 is preferably in a light-off state, but may be in a light-on state.

The display surface of the liquid crystal display module (liquid crystal display panel 20) may be divided into regions including one or more display regions in the display mode and one or more non-display regions in the non-display mode. Such a state can be achieved by a method employing a local dimming backlight as the backlight 10, for example. The local dimming backlight includes light sources (emission regions) arranged in respective regions, and can set the light source in each region in the light-on state (with any luminance) or the light-off state.

The local dimming backlight can provide a function of activating one region in the display mode (display region) and another region in the non-display mode (non-display region) simultaneously in one display surface to the liquid crystal display module (liquid crystal display panel 20). The liquid crystal display module (liquid crystal display panel 20) has only to be able to have such a configuration, and the display surface thereof may not be always divided into regions including the one or more display regions and the one or more non-display regions. Here, a non-display region in a display surface means a region whose mode is switched to the non-display mode in the display surface, and excludes regions such as a region always in the non-display state in the display surface (e.g., region only with the black matrix) and the frame region surrounding the display surface.

### <Switching Device>

The switching device 30 includes, in the following order from the liquid crystal display panel 20 side, a linearly polarized light reflector 31a, a switching liquid crystal cell 32, a linearly polarized light reflector 31b, and an anisotropic light scattering layer 33.

The linearly polarized light reflectors 31a and 31b each reflect incident linearly polarized light vibrating in the direction parallel to the reflection axis, and transmits incident linearly polarized light vibrating in the direction perpendicular to the reflection axis (direction parallel to the transmission axis).

Examples of the linearly polarized light reflectors 31a and 31b include reflective polarizers such as wire grid reflective polarizers and multilayer reflective polarizers.

The reflection axis of the linearly polarized light reflector 31a and the reflection axis of the linearly polarized light reflector 31b are preferably perpendicular to each other when, for example, the switching liquid crystal cell 32 is a VA mode liquid crystal cell. This means that the linearly polarized light reflectors 31a and 31b are disposed in crossed Nicols, and thus a high reflectance can be effectively achieved.

The switching liquid crystal cell 32 is switchable between a switching mode of converting the vibration direction of incident polarized light and a non-switching mode of not converting the vibration direction of incident polarized light. In Embodiment 1, the switching liquid crystal cell 32 is switchable between a switching mode of converting the vibration direction of linearly polarized light transmitted through the linearly polarized light reflector 31a or the linearly polarized light reflector 31b and a non-switching mode of not converting the vibration direction of ouch light, according to the state with voltage applied or no voltage applied. The switching liquid crystal cell 32 may be, for example, a liquid crystal cell in a mode such as the TN mode or the VA mode. For example, the switching liquid crystal cell 32, when it is in the VA mode, operates in a switching mode of rotating the vibration direction of incident linearly polarized light by 180° (providing an in-plane retardation of a half of a wavelength (λ/2) to the light) with voltage applied, while operating in a non-switching mode of not rotating the vibration direction of incident linearly polarized light with no voltage applied.

The anisotropic light scattering layer 33 is a light scattering layer that scatters incident light at a specific azimuth. Herein, “scattering incident light at a specific azimuth” means scattering at least incident light from the normal direction at the specific azimuth, which causes the scattered light to have a higher intensity at the specific azimuth than at the other azimuths (causes the intensity of the scattered light to depend on the azimuth angle). In the display state of the display device 1, a blurred image on the liquid crystal display module (liquid crystal display panel 20) is less likely to be perceived when the image is observed through the anisotropic light scattering layer 33 than when the image is observed through an isotropic light scattering layer.

The haze of the anisotropic light scattering layer 33 is 50% or higher, preferably 90% or higher. Also, the full width at half maximum of the luminance at the first azimuth is greater than the full width at half maximum of the luminance at the second azimuth, the first azimuth being the specific azimuth where light scattered by the anisotropic light scattering layer 33 has maximum intensity, the second azimuth being an azimuth where the scattered light has minimum intensity. The full width at half maximum of the luminance at the specific azimuth (first azimuth) is also less than ten times, preferably 1.2 to 8.0 times, the full width at half maximum of the luminance at the azimuth (second azimuth). With these properties, the display device 1 is more likely to appear white in the non-display state.

The haze of the anisotropic light scattering layer 33 is defined by the following formula (H) using the total light transmittance and the diffuse transmittance of the anisotropic light scattering layer 33 alone, independently of the switching device 30.

Haze=100×“diffusion transmittance”/“total light transmittance” (H)

If the haze of the anisotropic light scattering layer 33 is lower than 50%, the display device 1 appears like a mirror in the non-display state and is not likely to appear white.

The full width at half maximum of the luminance of light scattered by the anisotropic light scattering layer 33 is determined by, for example, irradiating the anisotropic light scattering layer 33 lifting a laser or a parallel light source (e.g., a device converting light emitting from a halogen lamp, for example, into parallel light using an optical system) and measuring the light distribution characteristics of the light transmitted through the anisotropic light scattering layer 33. The measurement device used may be, for example, a variable angle spectrophotometer from Kippon Denshoku Industries Co., Ltd. Such measurement enables determination of the specific azimuth where the scattered light has maximum intensity and the azimuth where the scattered light has minimum intensity. In simple terms, the azimuth where a beam from a laser pointer, when transmitted through the anisotropic light scattering layer 33, spreads wider corresponds to the specific azimuth. When the full width at half maximum of the luminance at the specific azimuth where the light scattered by the anisotropic light scattering layer 33 has maximum intensity is ten times or more of the full width at half maximum of the luminance at the azimuth where the scattered light has minimum intensity, the viewing angle dependence excessively increases, widening the region of the display device 1 not likely to appear white in the non-display state. As a result, the display device 1 appears like a mirror in the non-display state, and is not likely to appear white.

Disposing the anisotropic light scattering layer 33 in the display device 1 as described above leads to the white appearance in the non-display state and reduction of blurred images in the display state.

The anisotropic light scattering layer 33 may include a lenticular lens and an isotropic light scattering layer, may include an anisotropic microlens array, may include needle filler (e.g., needle filler disclosed in JP 4959307 B), or may include a combination thereof.

The anisotropic light scattering layer 33, when including a lenticular lens and an isotropic light scattering layer, may have a structure shown in FIG. 2 or 3, for example. FIG, 2 is a schematic cross-sectional view showing Structure Example 1 of an anisotropic light scattering layer. The structure shown in FIG. 2 includes an isotropic light scattering layer 33b in a lenticular lens 33a. FIG. 3 is a schematic cross-sectional view showing Structure Example 2 of the anisotropic light scattering layer. The structure shown in FIG. 3 includes the lenticular lens 33a on the isotropic light scattering layer 33b.

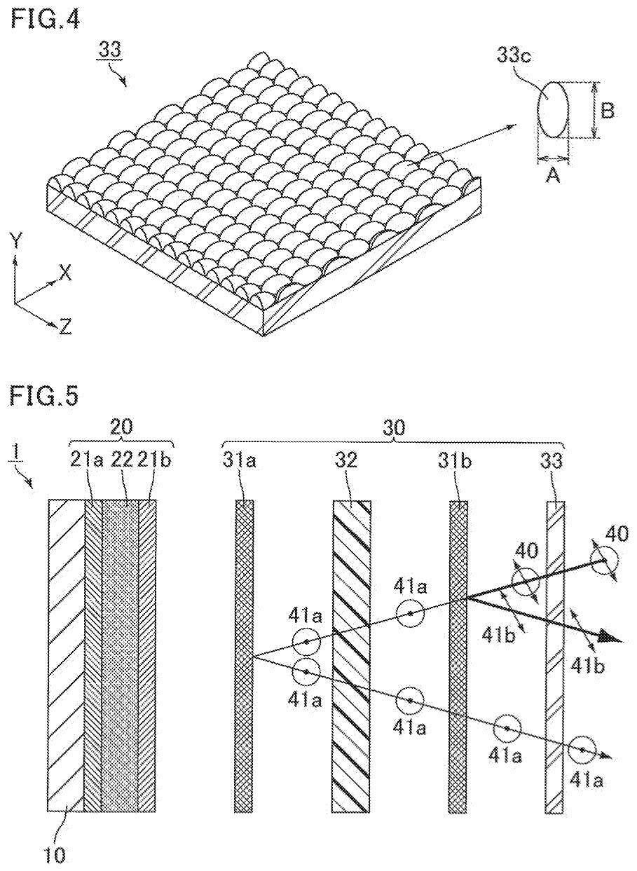

The anisotropic light scattering layer 33, when including an anisotropic microlens array, may have a structure shown in FIG. 4, for example. FIG. 4 is a schematic perspective view showing Structure Example 3 of the anisotropic light scattering layer. The structure shown in FIG. 4 includes microlenses 33c laid over with a shift amount of A/2 and B/2. “A” represents the minor axis of each microlens 33c and “B” represents the major axis of the microlens 33c, in a plan view. For example, in the case where the microlenses 33c are made of a methyl polymethacrylate resin (refractive index: 1.49) and each have an A of 100 μm and a B of 200 μm, the full width at half maximum of the luminance is 45° in the X direction in which the scattered light has maximum intensity. This is greater than 19° in the Y direction in which the scattered light has minimum intensity and is less than ten times 19°. Thereby, the scattered light becomes anisotropic.

In the case where the anisotropic light scattering layer 33 used is one having projections and recesses on its surface, such as one including a lenticular lens and an isotropic light scattering layer or one including an anisotropic microlens array, light is effectively scattered in the same plane (in an uneven plane), the display device 1 is likely to appear white in the non-display state and cause blurred images to be less perceivable in the display state. Here, an air layer may be formed or a resin having a higher or lower refractive index than the projections and recesses may be injected between the projections and recesses of the anisotropic light scattering layer 33 and the linearly polarized light reflector 31b.

In the switching device 30, between the linearly polarized light reflector 31a and the switching liquid crystal cell 32, a different anisotropic light scattering layer having the same function as the anisotropic light scattering layer 33 may be disposed.

The operating principle of the display device 1 is described below. The following shows an example in which the switching liquid crystal cell 32 is a VA mode liquid crystal cell.

### <In the Non-Display State>

FIG. 5 is a schematic cress-sectional view illustrating the operating principle of the display device of Embodiment 1 in a non-display state. For convenience, FIG. 5 separately shows the liquid crystal display panel 20, the linearly polarized light reflector 31a, the switching liquid crystal cell 32, the linearly polarized light reflector 31b, and the anisotropic light scattering layer 33.

In the non-display state of the display device 1, the liquid crystal display module (liquid crystal display panel 20) is set in the non-display mode. Meanwhile, as shown in FIG. 5, external light 40 (unpolarized light) incident on the anisotropic light scattering layer 33 side of the display device 1 is scattered by the anisotropic light scattering layer 33 toward the linearly polarized light reflector 31b.

Linearly polarized light 41a included in the external light 40 scattered by the anisotropic light scattering layer 33 toward the linearly polarized light reflector 31b is transmitted through the linearly polarized light reflector 31b, and linearly polarized light 41b (linearly polarized light vibrating in the direction perpendicular to the linearly polarized light 41a) in the external light 40 is reflected by the linearly polarized light reflector 31b toward the anisotropic light scattering layer 33. In the linearly polarized light reflector 31b, the transmission axis is set parallel to the vibration direction of the linearly polarized light 41a (perpendicular to the vibration direction of the linearly polarized light 41b), while the reflection axis is set parallel to the vibration direction of the linearly polarized light 41b (perpendicular to the vibration direction of the linearly polarized light 41a).

The linearly polarized light 41a transmitted through the linearly polarized light reflector 31b is transmitted through the switching liquid crystal cell 32 set in the non-switching mode (with no voltage applied) and then reflected by the linearly polarized light reflector 31a toward the switching liquid crystal cell 32. In the linearly polarized light reflector 31a, the transmission axis is set perpendicular to the vibration direction of the linearly polarized light 41a (parallel to the vibration direction of the linearly polarized light 41b), while the reflection axis is set parallel to the vibration direction of the linearly polarized light 41a (perpendicular to the vibration direction of the linearly polarized light 41b). In other words, the linearly polarized light reflectors 31a and 31b are arranged in crossed Nicols. The linearly polarized light 41a reflected by the linearly polarized light reflector 31a toward the switching liquid crystal cell 32 is sequentially transmitted through the switching liquid crystal cell 32 and the linearly polarized light reflector 31b, scattered by the anisotropic light scattering layer 33, and thereby emitted from the display device 1.

The linearly polarized light 41b reflected by the linearly polarized light reflector 31b toward the anisotropic light scattering layer 33 is scattered by the anisotropic light scattering layer 33, and thereby emitted from the display device 1.

Consequently, the display device 1 in the non-display state shows light reflected (scattered) in the display device 1, and thus appears white. Also, since the linearly polarized light 41b in the external light 40 is reflected by the linearly polarized light reflector 31b and the linearly polarized light 41a in the external light 40 not reflected by the linearly polarized light reflector 31b is reflected by the linearly polarized light reflector 31a, a high reflectance is achieved. Thereby, the display device 1 in the non-display state achieves white appearance with a high reflectance. Herein, “white with a high reflectance” means a state exhibiting Lambertian reflection (including many scattered components) rather than specular reflection, and having a reflectance of 40% or higher.

### <In the Display State>

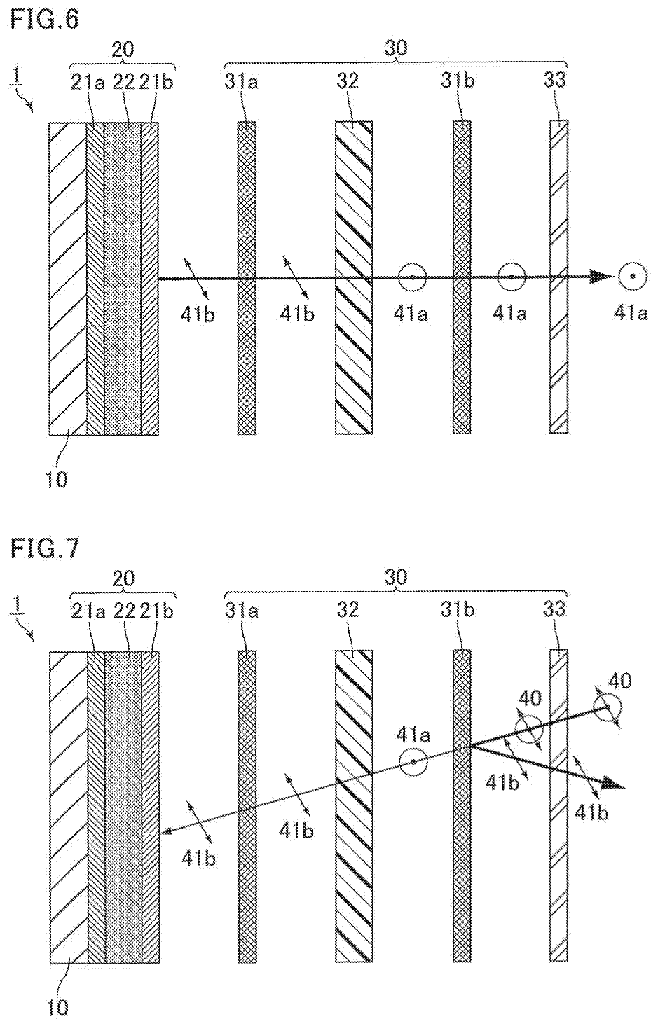

FIGS. 6 and 7 are schematic cross-sectional views illustrating the operating principle of the display device of Embodiment 1 in the display state. For convenience, FIGS. 6 and 7 each separately show the liquid crystal display panel 20, the linearly polarized light reflector 31a, the switching liquid crystal cell 32, the linearly polarized light reflector 31b, and the anisotropic light scattering layer 33.

In the display state of the display device 1, the liquid crystal display module (liquid crystal display panel 20) is set in the display mode. Specifically, as shown in FIG. 6, light emitted from the backlight 10 is emitted as the linearly polarized light 41b (display light: image displayed on the liquid crystal display module (liquid crystal display panel 20)) to the linearly polarized light reflector 31a side of the liquid crystal display panel 20. The linearly polarized light 41b vibrates in the direction parallel to the transmission axis of the absorptive polarizer 21b.

The linearly polarized light 41b emitted from the liquid crystal display panel 20 is transmitted through the linearly polarized light reflector 31a. Then, when the linearly polarized light 41b is transmitted through the switching liquid crystal cell 32 set in the switching mode (with voltage applied), the vibration direction of the linearly polarized light 41b is rotated by 180° (provided with an in-plane retardation of a half of a wavelength (λ/2)), so that the linearly polarized light 41b is converted into the linearly polarized light 41a. The linearly polarized light 41c transmitted through the switching liquid crystal cell 32 is transmitted through the linearly polarized light reflector 31b, scattered by the from the display device 1.

As described above, the display device 1 in the display state shows images on the liquid crystal display module (liquid crystal display panel 20). Here, the anisotropic light scattering layer 33 achieves the effect of reducing blurred images.

In the display state of the display device 1, while the linearly polarized light 41b is emitted from the liquid crystal display panel 20, the external light 40 (unpolarized light) is incident on the anisotropic light scattering layer 33 side as shown in FIG. 7. The external light 40 is scattered by the anisotropic light scattering layer 33 toward the linearly polarized light reflector 31b.

The linearly polarized light 41a included in the external light 40 scattered by the anisotropic light scattering layer 33 toward the linearly polarized light reflector 31b is transmitted through the linearly polarized light reflector 31b, while the linearly polarized light 41b in the external light 40 is reflected by the linearly polarized light reflector 31b toward the anisotropic light scattering layer 33.

Then, when the linearly polarized light 41a transmitted through the linearly polarized light reflector 31b is transmitted through the switching liquid crystal cell 32 set in the switching mode (with voltage applied), the vibration direction of the linearly polarized light 41a is rotated by 180° (provided with an in-plane retardation of a half of a wavelength (λ/2)), so that the linearly polarized light 41a is converted into the linearly polarized light 41b. The linearly polarized light 41b transmitted through the switching liquid crystal cell 32 is transmitted through the linearly polarized light reflector 31a, and appropriately absorbed by the liquid crystal display panel 20 and the backlight 10.

Meanwhile, the linearly polarized light 41b reflected by the linearly polarized light reflector 31b toward the anisotropic light scattering layer 33 is scattered by the anisotropic light scattering layer 33, and thereby emitted from the display device 1.

As described above, in the display device i in the display state, part of the external light 40 (linearly polarized light 41b) is reflected by the linearly polarized light reflector 31b but is hardly reflected by the linearly polarized light reflector 31a, so that the influence of the external light 40 on the display quality is minimized.

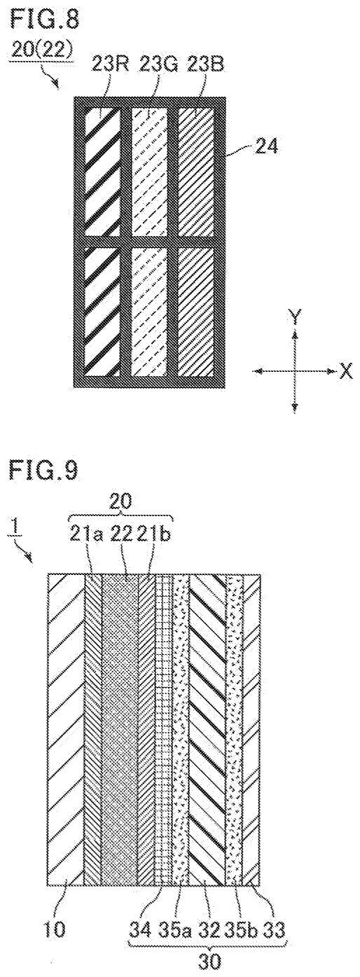

The display device 1, including the anisotropic light scattering layer 33 scattering incident light at the specific azimuth, achieves a white appearance in the non-display state and reduces blurred images in the display state. For achievement of both the white appearance and reduction of blurred images, the specific azimuth where the light scattered by the anisotropic light scattering layer 33 has maximum intensity is preferably set as shown in FIG. 8. FIG. 8 is a schematic plan view illustrating a preferred positional relationship between a liquid crystal display module and an anisotropic light scattering layer.

As shown in FIG. 8, in the display region of the liquid crystal display module, the liquid crystal display panel 20 (liquid crystal cell 22) includes pixel regions providing red display corresponding to red color filters 23R, pixel regions providing green display corresponding to green color filters 23G, and pixel regions providing blue display corresponding to blue color filters 23B, which are disposed in stripes and partitioned by the black matrix 24. Here, the specific azimuth where the light scattered by the anisotropic light scattering layer 33 has maximum intensity is set in the X direction perpendicular to the Y direction in which the stripes of the pixel regions (color filters) extend, so that the anisotropic light scattering layer 33 scatters incident light strongly in the X direction and weakly in the Y direction. In the X direction, the red color filters 23R, the green color filters 23G, and the blue color filters 23B are arranged in the stated order such that color filters in three different colors are arranged one after another. Here, blurred images are less likely to be perceived on the display device 1 in the display state and the display device 1 is more likely to appear white in the non-display state, even when the scattered light has an increased intensity in the X direction. Meanwhile, in the Y direction, the red color filters 23R, the green color filters 23G, and the blue color filters 23B are arranged independently of each other, and color filters in the same color are consecutively arranged. Since the scattered light has low intensity in the Y direction, blurred images on the display device 1 in the display state are less likely to be perceived.

For reduction of blurred images on the display device 1 in the display state, the liquid crystal display nodule preferably has a narrow directivity as a light distribution characteristic. Specifically, the liquid crystal display module preferably has a half-luminance angle of ±15° or smaller from a central axis defined as extending in the direction normal to the display surface of the liquid crystal display module (liquid crystal display panel 20).

In Embodiment 1, the linearly polarized light reflectors (linearly polarized light reflectors 31a and 31b) are disposed on the side remote from the anisotropic light scattering layer 33 and the side close to the anisotropic light scattering layer 33 of the switching liquid crystal cell 32 in the switching device 30, respectively. Yet, one linearly polarized light reflector may be disposed on one side of the switching liquid crystal cell 32.

In Embodiment 1, the linearly polarized light reflectors (linearly polarized light reflectors 31a and 31b) are disposed on the respective sides of the switching liquid crystal cell 32 in the switching device 30. Yet, for an increase in the reflectance, a stack of linearly polarized light reflectors may be disposed on at least one side of the switching liquid crystal cell 32, with the reflection axes of the linearly polarized light reflectors displaced from each other. For example, a stack of two linearly polarized light reflectors whose reflection axes form an angle of 0° to 40° may be disposed on at least one side of the switching liquid crystal cell 32. When the stack of two linearly polarized light reflectors is used in place of the linearly polarized light reflector 31a, the reflection axis of each of the two linearly polarized light reflectors preferably forms an angle of 0° to 20° with the reflection axis of the linearly polarized light reflector 31a. When the stack of two linearly polarized light reflectors is used in place of the linearly polarized light reflector 31b, the reflection axis of each of the two linearly polarized light reflectors preferably forms an angle of 0° to 20° with the reflection axis of the linearly polarized light reflector 31b.

### Embodiment 2

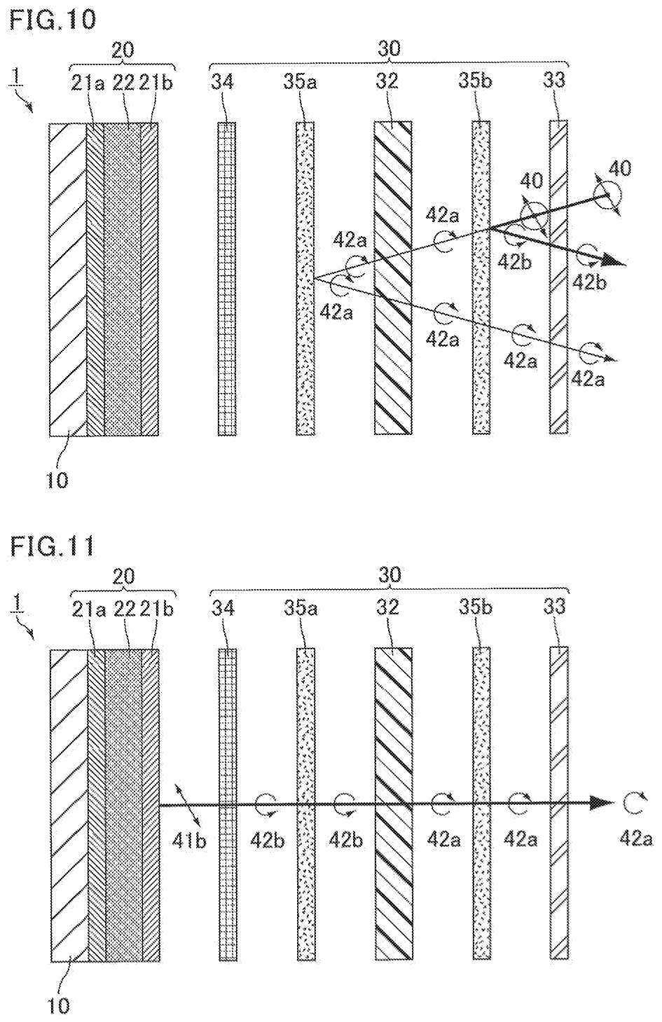

FIG. 9 is a schematic cross-sectional view of a switching device and a display device of Embodiment 2. Embodiment 2 is the same as Embodiment 1 except for the structure of the switching device. Hence, the points described above are not repeated below.

### <Switching Device>

As shown in FIG. 9, the switching device 30 includes, in the following order from the liquid crystal display panel 20 side, a λ/4 retarder 34, a circularly polarized light reflector 35a, the switching liquid crystal cell 32, a circularly polarized light reflector 35b, and the anisotropic light scattering layer 33.

The λ/4 retarder 34 is a retarder providing an in-plane retardation of a quarter of a wavelength (λ/4) to incident light having a wavelength λ.

The λ/4 retarder 34 is formed from, for example, a photopolymerizable liquid crystal material. The photopolymerizable liquid crystal material has a structure in which, for example, a photopolymerizable group such as an acrylate group or a methacrylate group is present at a terminal of a skeleton of a liquid crystal molecule.

The λ/4 retarder 34 can be formed by, for example, the following method. First, a photopolymerizable liquid crystal material is dissolved in an organic solvent such as propylene glycol monomethyl other acetate. The resulting solution is applied to a surface of a substrate (e.g., polyethylene terephthalate film) to form a film of the solution. The film of the solution is sequentially pre-baked, irradiated with light (e.g., ultraviolet light), and post-baked, whereby the λ/4 retarder 34 is formed.

The λ/4 retarder 34 can also be a stretched polymer film as well as those described above. The polymer film is formed from, for example, a cycloolefin polymer, polycarbonate, polysulfone, polyethersulfone, polyethylene terephthalate, polyethylene, polyvinyl alcohol, norbornene, triacetyl cellulose, or diacetyl cellulose.

The circularly polarized light reflectors 35a and 35b each reflect one of right circularly polarized light or left circularly polarized light incident thereon and transmit the other.

The circularly polarized light reflectors 35a and 35b preferably include cholesteric liquid crystals. The cholesteric liquid crystals have a helical structure and can be formed by adding a chiral agent to nematic liquid crystals. With a photoreactive chiral agent, subjecting the chiral agent together with a photopolymerization initiator to photoreaction enables formation of cholesteric liquid crystals having a desired helical pitch (helical period). Cholesteric liquid crystals selectively reflect circularly polarized light whose wavelength is the same as the helical pitch and whose rotational direction is the same as the twist direction of the helix.

The operating principle of the display device 1 is described below. The following shows an example in which the switching liquid crystal cell 32 is a VA mode liquid crystal cell and the circularly polarized light reflectors 35a and 35b include cholesteric liquid crystals.

### <In the Non-Display State>

FIG. 10 is a schematic cross-sectional view illustrating the operating principle of the display device of Embodiment 2 in a non-display state. For convenience, FIG. 10 separately shows the liquid crystal display panel 20, the λ/4 retarder 34, the circularly polarized light reflector 35a, the switching liquid crystal cell 32, the circularly polarized light reflector 35b, and the anisotropic light scattering layer 33.

In the display device 1 in the non-display state, the liquid crystal display module (liquid crystal display panel 20) is set in the non-display mode. Meanwhile, as shown in FIG. 10, the external light 40 (unpolarized light) incident on the anisotropic light scattering layer 33 side of the display device 1 is scattered by the anisotropic light scattering layer 33 toward the circularly polarized light reflector 35b.

Circularly polarized light 42a (one of right circularly polarized light or left circularly polarized light) included in the external light 40 scattered by the anisotropic light scattering layer 33 toward the circularly polarized light reflector 35b is transmitted through the circularly polarized light reflector 35b, and circularly polarized light 42b (the other of right circularly polarized light or left circularly polarized light) in the external light 40 is reflected by the circularly polarized light reflector 35b toward the anisotropic light scattering layer 33. In the circularly polarized light reflector 35b, the twist direction of the helixes of the cholesteric liquid crystals are set different from the rotational direction of the circularly polarized light 42a but set the same as the rotational direction of the circularly polarized light 42b.

The circularly polarized light 42a transmitted through the circularly polarized light reflector 35b is transmitted through the switching liquid crystal cell 32 set in the non-switching mode (with no voltage applied) and then reflected by the circularly polarized light reflector 35a toward the switching liquid crystal cell 32. In the circularly polarized light reflector 35a, the twist direction of the helixes of the cholesteric liquid crystals are set the same as the rotational direction of the circularly polarized light 42a but set different from the rotational direction of the circularly polarized light 42b. The circularly polarized light 42a reflected by the circularly polarized light reflector 35a toward the switching liquid crystal cell 32 is sequentially transmitted through the switching liquid crystal cell 32 and the circularly polarized light reflector 35b, scattered by the anisotropic light scattering layer 33, and thereby emitted from the display device 1.

The circularly polarized light 42b reflected by the circularly polarized light reflector 35b toward the anisotropic light scattering layer 33 is scattered by the anisotropic light scattering layer 33, and thereby emitted from the display device 1.

Consequently, the display device 1 in the non-display state shows light reflected (scattered) in the display device 1 and thus appears white. Also, since the circularly polarized light 42b in the external light 40 is reflected by the circularly polarized light reflector 35b and the circularly polarized light 42a in the external light 40 not reflected by the circularly polarized light reflector 35b is reflected fay the circularly polarized light reflector 35a, a high reflectance is achieved. Thereby, the display device 1 in the non-display state achieves white appearance with a high reflectance.

### <In the Display State>

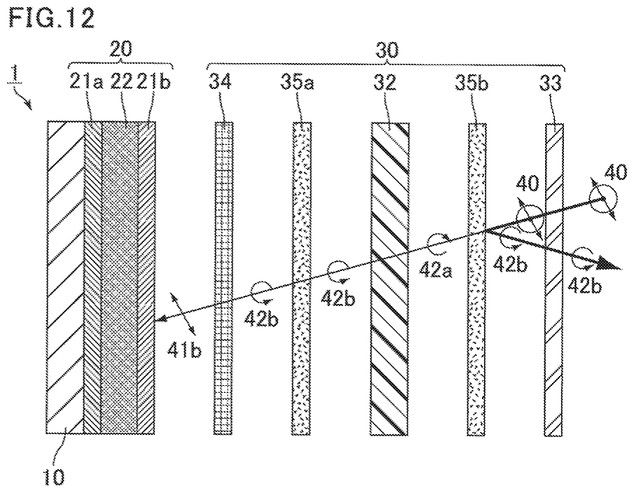

FIGS. 11 and 12 are schematic cross-sectional views illustrating the operating principle of the display device of Embodiment 2 in the display state. For convenience, FIGS. 11 and 12 separately show the liquid crystal display panel 20, the λ/4 retarder 34, the circularly polarized light reflector 35a, the switching liquid crystal cell 32, the circularly polarized light reflector 35b, and the anisotropic light scattering layer 33.

In the display state of the display device 1, the liquid crystal display module (liquid crystal display panel 20) is set in the display mode. Specifically, as shown in FIG. 11, light emitted from the backlight 10 is emitted as the linearly polarized light 41b (display light: image displayed on the liquid crystal display module (liquid crystal display panel 20)) to the λ/4 retarder 34 side of the liquid crystal display panel 20. The linearly polarised light 41b vibrates in the direction parallel to the transmission axis of the absorptive polarizer 21b.

The linearly polarized light 41b emitted from the liquid crystal display panel 20 is converted into the circularly polarized light 42b as it is transmitted through the λ/4 retarder 34. The circularly polarized light 42b may be either right circularly polarized light or left circularly polarized light, and is appropriately set according to the positional relationship between the transmission axis of the absorptive polarizer 21b and the in-plane slow axis of the λ/4 retarder 34 (they form an angle of approximately 45°).

The circularly polarized light 42b transmitted through the λ/4 retarder 34 is transmitted through the circularly polarized light reflector 35a. Then, when the circularly polarized light 42b is transmitted through the switching liquid crystal cell 32 set in the switching mode (with voltage applied), the vibration direction of the circularly polarized light 42b is rotated by 180° (provided with an in-plane retardation of a half of a wavelength (λ/2)), so that the circularly polarized light 42b is converted into the circularly polarized light 42a. The circularly polarized light 42a transmitted through the switching liquid crystal cell 32 is transmitted through the circularly polarized light reflector 35b, scattered by the anisotropic light scattering layer 33, and thereby emitted from the display device 1.

As described above, the display device 1 in the display state shows images on the liquid crystal display module (liquid crystal display panel 20). Here, the anisotropic light scattering layer 33 achieves the effect of reducing blurred images.

In the display state of the display device 1, while the linearly polarized light 41b is emitted from the liquid crystal display panel 20, the external light 40 (unpolarized light) is incident on the anisotropic light scattering layer 33 side as shown in FIG. 12. The external light 40 is scattered by the anisotropic light scattering layer 33 toward the circularly polarized light reflector 35b.

The circularly polarized light 42a included in the external light 40 scattered by the anisotropic light scattering layer 33 toward the circularly polarized light reflector 35b is transmitted through the circularly polarized light reflector 35b, while the circularly polarized light 42b in the external light 40 is reflected by the circularly polarized light reflector 35b toward the anisotropic light scattering layer 33.

Then, when the circularly polarized light 42a transmitted through the circularly polarized light reflector 35b is transmitted through the switching liquid crystal cell 32 set in the switching mode (with voltage applied), the vibration direction of the circularly polarized light 42a is rotated by 180° (provided with an in-plane retardation of a half of a wavelength (λ/2)), so that the circularly polarized light 42a is converted into the circularly polarized light 42b. The circularly polarized light 42b transmitted through the switching liquid crystal cell 32 is transmitted through the circularly polarized light reflector 35a and the λ/4 retarder 34, and thereby converted into the linearly polarized light 41b. The linearly polarized light 41b transmitted through the λ/4 retarder 34 is appropriately absorbed by the liquid crystal display panel 20 and the backlight 10.

Meanwhile, the circularly polarized light 42b reflected by the circularly polarized light reflector 35b toward the anisotropic light scattering layer 33 is scattered by the anisotropic light scattering layer 33, and thereby emitted from the display device 1.

As described above, in the display device 1 in the display state, part of the external light 40 (circularly polarized light 42b) is reflected by the circularly polarized light reflector 35b but is hardly reflected by the circularly polarized light reflector 35a, so that the influence of the external light 40 on the display quality is minimized.

In Embodiments 1 and 2, the cases are described where the display light emitted from the liquid crystal display module (liquid crystal display panel 20) is linearly polarized light (linearly polarized light 41b). Yet, the display light may be light other than linearly polarized light, and may be circularly polarized light or elliptically polarized light, for example. The display light may be in such a polarized state or nay be in the state randomly including various polarization states, i.e., an unpolarized state.

In Embodiments 1 and 2, the cases are described where the switching device 30 is combined with a liquid crystal display module including the backlight 10 and the liquid crystal display panel 20. Yet, the switching device 30 may be combined with a self-luminous display panel such as an organic electroluminescent display panel or an LED display panel. The switching device 30 is not necessarily combined with a display module such as a liquid crystal display module, and may be combined with, for example, a black film (light-shielding plate). In this case, the switching liquid crystal cell 32 is switched between the switching mode and the non-switching n,ode, so that the display device appears black, the natural color of the black film, or appears white with a high reflectance.

### [Evaluation 1]

In the display device (FIG. 1) of Embodiment 1, the appearance of the display device in the non-display state when the haze of the anisotropic light scattering layer was varied was subjected to sensory evaluation. The results are shown in Table 1. The evaluation criteria were as follows.

A: Display device appeared as white as components such as housings of home appliances.

B: Display device appeared whitish.

C: Display device did rot appear white.

In this evaluation, the full width at half maximum of the luminance at the azimuth where the light scattered by the anisotropic light scattering layer has maximum intensity was 1.2 times the full width at half maximum of the luminance at the azimuth where the scattered light has minimum intensity.

TABLE 1

| Haze of anisotropic | Appearance of display |
|---|---|
| light scattering layer | device in non-display |
| (%) | state |
| 30 | C |
| 40 | C |
| 50 | B |
| 60 | B |
| 73 | B |
| 85 | B |
| 90 | A |
| 93 | A |

As shown in Table 1, the display device in the non-display state was likely to appear white when the haze of the anisotropic light scattering layer was 50% or higher, preferably 90% or higher.

### [Evaluation 2]

The display device (FIG. 1) of Embodiment 1 was subjected to the following sensory evaluations: (1) the width of the region appearing white in the non-display state (hereinafter, simply referred to as “width of white region in the non-display state”) and (2) blurred images in the display state. These evaluations were performed by varying the ratio of the full width at half maximum at the azimuth where the light scattered by the anisotropic light scattering layer has maximum intensity to the full width at half maximum of the luminance at the azimuth where the scattered light has minimum intensity (hereinafter, simply referred to as “ratio between full widths at half maximum of luminances”), i.e., “full width at half maximum of luminance at azimuth where scattered light has maximum intensity”/“full width at half maximum of luminance at azimuth where scattered light has minimum intensity”. The results are shown in Table 2. The evaluation criteria were as follows.

### (1) Width of White Region in the Non-Display State

A: Width was the same as in the case where the ratio between full widths at half maximum of luminances was 1.0.

B: Width was smaller than in the case of “A”.

C: Width was smaller than in the case of “B”.

### (2) Blurred Images in the Display State

A: Not perceivable.

B: Slightly perceivable.

C: Significantly perceivable.

In the evaluations, the haze of the anisotropic light scattering layer was 90%.

TABLE 2

| | |
|---|---|
| Anisotropic light | |
| scattering layer | |
| Ratio between full | Display devices |

| widths at half | Width of white | |
|---|---|---|
| maximum of | region in non- | Blurred images |
| luminances | display state | in display state |
| 1.0 | — | — |
| 1.2 | A | A |
| 1.5 | A | A |
| 2.0 | B | B |
| 5.0 | B | B |
| 8.0 | B | B |
| 10 | C | B |

As shown in Table 2, the display device in the non-display state was likely to appear white and blurred images in the display state were not likely to be perceived when the ratio between the full widths at half maximum of the luminances of the anisotropic light scattering layer was greater than 1.0 and smaller than 10, preferably 1.2 to 8.0.

The results of Evaluations 1 and 2 show that with an anisotropic light scattering layer having a haze of 50% or higher and a ratio between full widths at half maximum of luminances of greater than 1.0 and smaller than 10, the display device in the non-display state is likely to appear white and causes blurred images to be less perceivable in the display state.

What is claimed is:

1. A switching device comprising:
a switching liquid crystal cell switchable between a switching mode of converting a vibration direction of incident polarized light and a non-switching node of not converting the vibration direction of the incident polarized light;
an anisotropic light scattering layer configured to scatter incident light at a specific azimuth; and
a polarized light reflective layer disposed on one or both of a side remote from the anisotropic light scattering layer of the switching liquid crystal cell and a side close to the anisotropic light scattering layer of the switching liquid crystal cell,
wherein in the anisotropic light scattering layer, a haze is 50% or higher and a full width at half maximum of luminance at a first azimuth is greater than a full width at half maximum of the luminance at a second azimuth and less than ten times the full width at half maximum of the luminance at the second azimuth, the first azimuth being the specific azimuth where the light scattered by the anisotropic light scattering layer has maximum intensity, the second azimuth being an azimuth where the scattered light has minimum intensity.

2. The switching device according to claim 1,
wherein the polarized light reflective layer includes a first polarized light reflective layer disposed on the side remote from the anisotropic light scattering layer of the switching liquid crystal cell and a second polarized light reflective layer disposed on the side close to the anisotropic light scattering layer of the switching liquid crystal cell.

3. The switching device according to claim 2,
wherein the first polarized light reflective layer and the second polarized light reflective layer each include at least one linearly polarized light reflector.

4. The switching device according to claim 3,
wherein one or both of the first polarized light reflective layer and the second polarized light reflective layer include(s) a stack of two linearly polarized light reflectors whose reflection axes form an angle of 0° to 40°.

5. The switching device according to claim 2,
wherein the first polarized light reflective layer and the second polarized light reflective layer each include a circularly polarized light reflector.

6. The switching device according to claim 5,
wherein the circularly polarized light reflector includes a cholesteric liquid crystal.

7. The switching device according to claim 5,
wherein a λ/4 retarder is disposed on a side remote from the switching liquid crystal cell of the first polarized light reflective layer.

8. The switching device according to claim 1,
wherein the anisotropic light scattering layer includes a lenticular lens and an isotropic light scattering layer.

9. The switching device according to claim 1,
wherein the anisotropic light scattering layer includes an anisotropic microlens array.

10. The switching device according to claim 1,
wherein the anisotropic light scattering layer includes needle filler.

11. A display device comprising:
a display module; and
the switching device according to claim 1.

12. The display device according to claim 11,
wherein the display module is a liquid crystal display module including, in the following order toward the switching device, a backlight and a liquid crystal display panel.

13. The display device according to claim 11,
wherein the display module is an organic electroluminescent display panel.

14. The display device according to claim 11,
wherein the display module includes a display region where pixel regions providing display in different colors are arranged in stripes, and
the specific azimuth where the light scattered by the anisotropic light scattering layer has maximum intensity is perpendicular to an azimuth where the stripes of the pixel regions extend.

15. The display device according to claim 11,
wherein the display module has light distribution characteristics that give a half-luminance angle of ±15° or smaller from a central axis defined as extending in a direction normal to a display surface.
